(19) United States
(12) Patent Application Publication
(10) Pub. No.: US 2008/0263886 A1
(43) Pub. Date: Oct. 30, 2008

(54) Tape measure with a self-regulating speed control mechanism

(76) Inventor: Dong Hun Kang, Busan (KR)

Correspondence Address: WENDEROTH, LIND & PONACK, L.L.P., 2033 K STREET N. W., SUITE 800, WASHINGTON, DC, 20006-1021, US

(21) Appl. No.: 12/078,619

(22) Filed: Apr. 2, 2008

(30) Foreign Application Priority Data
Apr. 24, 2007 (KR) 10-2007-0039938

(51) Int. Cl. G01B 3/10

(52) U.S. Cl. 33/767

(57) ABSTRACT

Disclosed herein is a tape measure with a self-regulating speed control mechanism. The tape measure is capable of self-regulating its speed so that the retraction speed of a blade is not too fast or slow, and does not introduce any noise to the working environment in the case where the speed of the blade is not reduced. According to the present invention, a rotary brake part is elastically biased by a second elastic member, and is brought into contact with a stationary brake part only when the rotating speed of a bobbin is very fast.

### BACKGROUND OF THE INVENTION

1. Field of the Invention

The present invention relates generally to a tape measure and, more particularly, to a tape measure with a self-regulating speed control mechanism, which self-regulates the speed at which an extended blade returns into a casing, thus preventing the retraction speed of the blade from exceeding a predetermined speed.

2. Description of the Related Art

Generally, a tape measure includes a casing in which a bobbin is rotatably provided. One end of the blade (also referred to as “tape”) is wound around the bobbin, while the other end of the blade is exposed outside the casing. Thus, by pulling the end of the blade that is exposed outside the casing, measurements can be made.

In order to wind the blade around the bobbin again after the measurements have been completed, a first elastic member is provided on the bobbin and provides rotating force. The first elastic member usually comprises a plate spring which is wound in a coil shape.

As such, while the blade is returned to its original position by the elastic force of the first elastic member, the retraction speed of the blade is gradually increased by the elastic force of the first elastic member. Thus, when the extended blade is very long, acceleration is excessive, so that a user using the tape measure or nearby people may be injured or the tape measure itself may be damaged.

In order to solve the problem, U.S. Pat. No. 3,889,897, which is incorporated herein and is entitled “COILABLE TAPE MEASURING DEVICE HAVING A SELF-REGULATING SPEED CONTROL MECHANISM”, was proposed, and was registered on Jun. 17, 1975.

According to the cited document, a brake member, which is called a lug, is rotatably provided on a sidewall of a bobbin (also called a “reel”) via a pivot post. Further, a shoulder protrudes from the casing towards the interior of the casing. Thereby, when the bobbin rotates, the lug also rotates together with the bobbin and is brought into contact with the shoulder by centrifugal force, so that the speed of the bobbin is reduced.

The conventional tape measuring device is advantageous in that the device itself can reduce the speed of the bobbin. However, the conventional tape measuring device is problematic in that the lug moves freely at normal times, so that it strikes surrounding parts (especially the shoulder), and thus noise is undesirably generated. Even when the bobbin rotates very slowly, the lug strikes the shoulder, thus undesirably generating noise. The noise leads a user to mistakenly believe that the tape measuring device has a problem. This consequently lowers consumer trust in the tape measuring device.

The conventional tape measuring device is problematic in that, when the bobbin rotates, the lug always reduces the speed of the bobbin, thus preventing the bobbin from rotating at a reasonable high speed. That is, excessively fast rotation of the bobbin causes a problem, but excessively slow rotation of the bobbin irritates a user.

For these reasons, although the conventional tape measuring device was proposed in 1973, its marketability is very low.

Since then, several attempts have been made to automatically reduce the retraction speed of the blade. However, the conventional tape measures proposed by the attempts are problematic in that the construction thereof is very complex, or it is difficult to use the tape measures stably and continuously, or a user must manually control the speed. Therefore, a tape measure that is capable of self-regulating the speed of the bobbin (or blade) has not been successfully marketed to date.

### SUMMARY OF THE INVENTION

Accordingly, the present invention has been made keeping in mind the above problem occurring in the prior art, and an object of the present invention is to provide a new tape measure, which is capable of self-regulating its speed so that the retraction speed of a blade is not too fast or slow, and does not introduce any noise to the working environment in the case where the speed of the blade is not reduced.

In order to accomplish the above object, the present invention provides a tape measure with a self-regulating speed control mechanism, including a rotary brake part which is provided on a sidewall of a bobbin in such a way as to change a distance from a rotation center of the bobbin, and is rotated along with the bobbin when the bobbin rotates, so that centrifugal force acts on the rotary brake part, a stationary brake part which protrudes from a casing towards the sidewall of the bobbin on which the rotary brake part is provided, and a second elastic member which is provided on the sidewall of the bobbin and elastically biases the rotary brake part in a direction leading away from the stationary brake part, wherein, when the centrifugal force acting on the rotary brake part by rotation of the bobbin exceeds an elastic force of the second elastic member, the rotary brake part comes into contact with the stationary brake part, thus preventing a rotating speed of the bobbin from increasing.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a vertical sectional view of a tape measure, according to the first embodiment of the present invention, when viewing the tape measure from the side;

FIG. 2 is a vertical sectional view of the tape measure, according to the first embodiment of the present invention, when viewing the tape measure from the front;

FIG. 3 is a cutaway perspective view of FIG. 1;

FIG. 4 is a view illustrating the operation of the tape measure of FIG. 1;

FIGS. 5 and 6 are views showing tape measures according to modifications of the first embodiment;

FIG. 7 is a cutaway perspective view showing a tape measure according to the second embodiment of the present invention;

FIG. 8 is a view illustrating the operation of the tape measure of FIG. 7; and

FIG. 9 is a view showing a tape measure according to a modification of the second embodiment.

### DESCRIPTION OF THE PREFERRED EMBODIMENTS

Hereinafter, the construction and operation of a tape measure according to the first embodiment of the present invention will be described in detail.

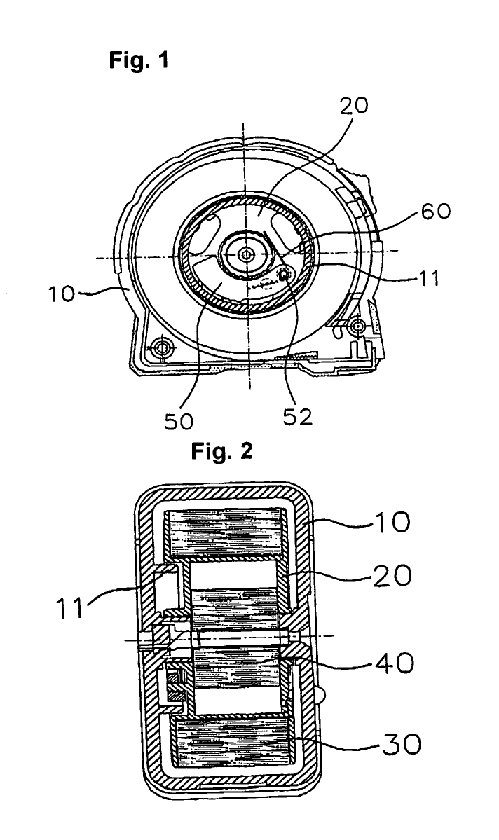

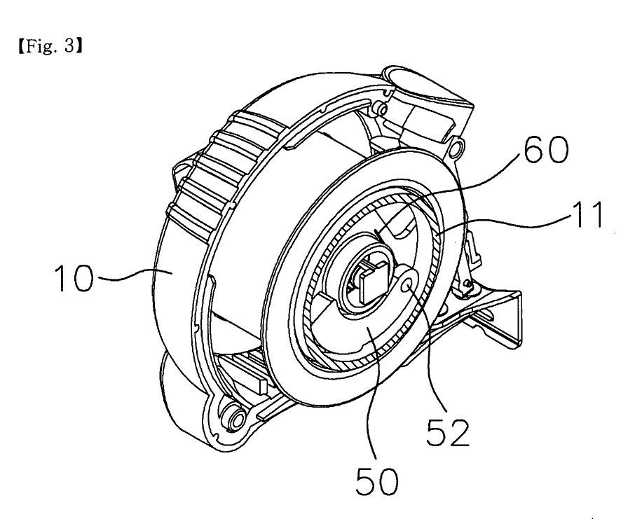

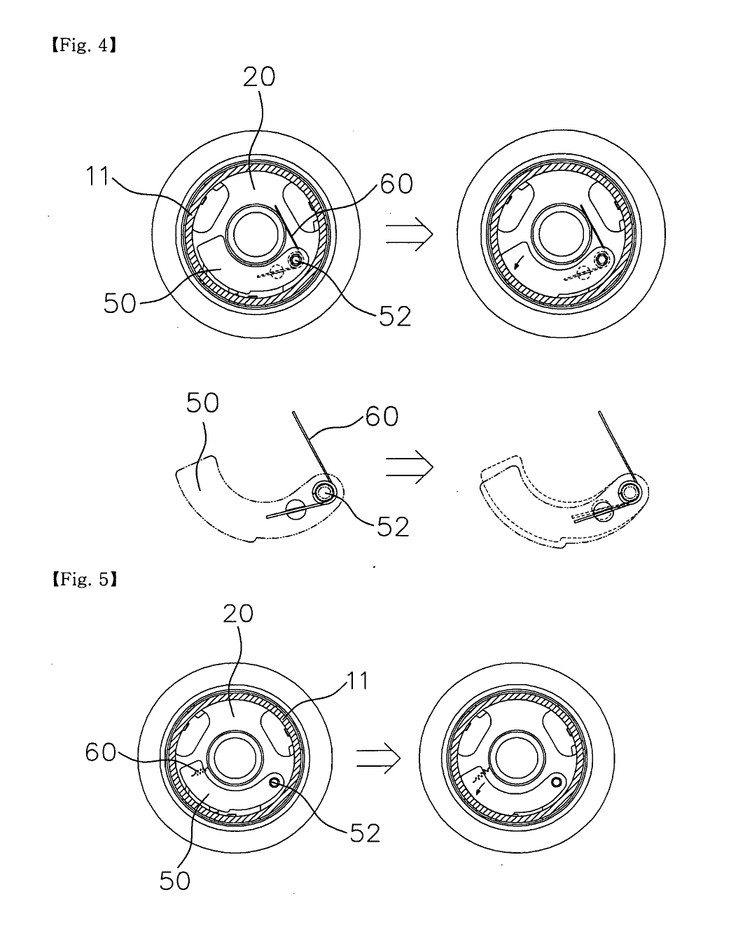

FIG. 1 is a vertical sectional view of a tape measure, according to the first embodiment of the present invention, when viewing the tape measure from the side, FIG. 2 is a vertical sectional view of the tape measure, according to the first embodiment of the present invention, when viewing the tape measure from the front, FIG. 3 is a cutaway perspective view of FIG. 1, and FIG. 4 is a view illustrating the operation of the tape measure of FIG. 1.

According to this embodiment, the tape measure includes a casing 10, a stationary brake part 11, a bobbin 20, a blade 30, a first elastic member 40, a rotary brake part 50, and a second elastic member 60.

The bobbin 20 is rotatably provided in the casing 10.

One end of the blade 30 is wound around the bobbin 20. Similarly to a general tape measure, graduations are marked on the blade 30 in the longitudinal direction thereof to measure lengths.

The other end of the blade 30 is exposed to the outside of the casing 10. Generally, when the graduations are marked on the tape measure, the other end of the blade 30 becomes a reference point.

Further, the first elastic member 40 provides rotating force to the bobbin 20 so as to restore the extended blade 30 to its original position. Generally, the first elastic member 40 uses a plate spring which is wound in a coil shape.

The casing 10, the bobbin 20, the blade 30, and the first elastic member 40, which are constructed as described above, adopt the general construction of a conventional tape measure. Such a construction may be variously changed.

The rotary brake part 50 is provided at a predetermined position on the sidewall of the bobbin 20.

When the bobbin 20 rotates, the rotary brake part 50 is rotated along with the bobbin 20.

In this case, the rotary brake part 50 is not fixed at one position. The rotary brake part 50 is movably or rotatably provided on the bobbin 20 in such a way as to change the distance from the rotation center of the bobbin 20.

In order to change the distance of the rotary brake part 50 from the rotation center of the bobbin 20, according to this embodiment, the rotary brake part 50 is supported at one end thereof by the sidewall of the bobbin 20 via a pivot shaft 52.

Thus, the rotary brake part 50 may rotate along with the bobbin 20. Further, if there were no other member present, the rotary brake part 50 would be able to pivot on the pivot shaft 52. However, the rotating radius of the rotary brake part 50 is limited within a predetermined range by the second elastic member 60, which will be described below.

Meanwhile, the stationary brake part 11 protrudes from the casing 10 to the sidewall of the bobbin 20 on which the rotary brake part 50 is provided. According to this embodiment, the stationary brake part 11 has a circular ring shape such that the center of the stationary brake part 11 is identical with the rotation center of the bobbin 20.

Thus, when the bobbin 20 rotates, so that the rotary brake part 50 rotates and comes into contact with the stationary brake part 11, the rotating speed of the bobbin 20 is reduced.

However, in the case where the tape measure is not in use or the rotating speed of the bobbin 20 is low, the second elastic member 60 prevents the rotary brake part 50 from contacting the stationary brake part 11.

According to this embodiment, a torsion spring is used as the second elastic member 60. The torsion spring is secured at the center thereof to the pivot shaft 52. One end of the torsion spring is supported by the bobbin 20, while the other end of the torsion spring is supported by the rotary brake part 50.

That is, the second elastic member 60 elastically supports the pivoting rotation of the rotary brake member 50, so that the rotary brake part 50 is elastically biased in a direction leading away from the stationary brake part 11.

Thus, in the case where the tape measure is not in use or the rotating speed of the bobbin 20 is low, the rotary brake part 50 is not in contact with the stationary brake part 11 due to the elastic force of the second elastic member 60.

However, when the rotating speed of the bobbin 20 is increased, so that the centrifugal force acting on the rotary brake part 50 exceeds the elastic force of the second elastic member 60, as shown in the right side of FIG. 4, the rotary brake part 50 rotates counterclockwise, and comes into contact with the stationary brake part 11, thus preventing the rotating speed of the bobbin 20 from increasing, or reducing the rotating speed of the bobbin 20.

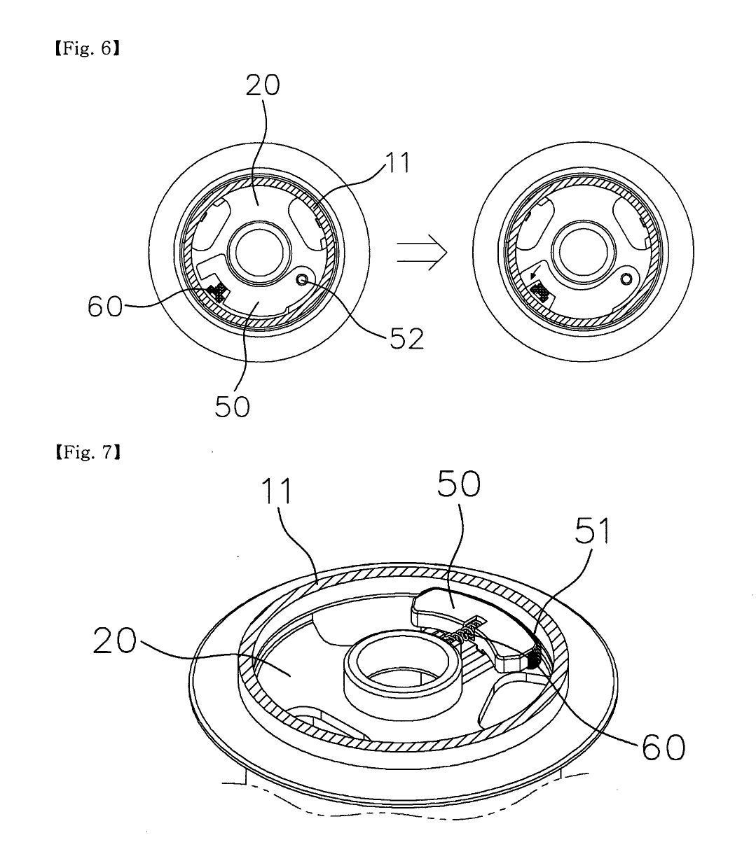

FIGS. 5 and 6 show modifications of the first embodiment.

According to the modification of FIG. 5, a coil spring is used as the second elastic member 60. In the modification of FIG. 6, a compressible rubber material is used as the second elastic member 60.

Hereinafter, the construction and operation of a tape measure according to the second embodiment of the present invention will be described in detail.

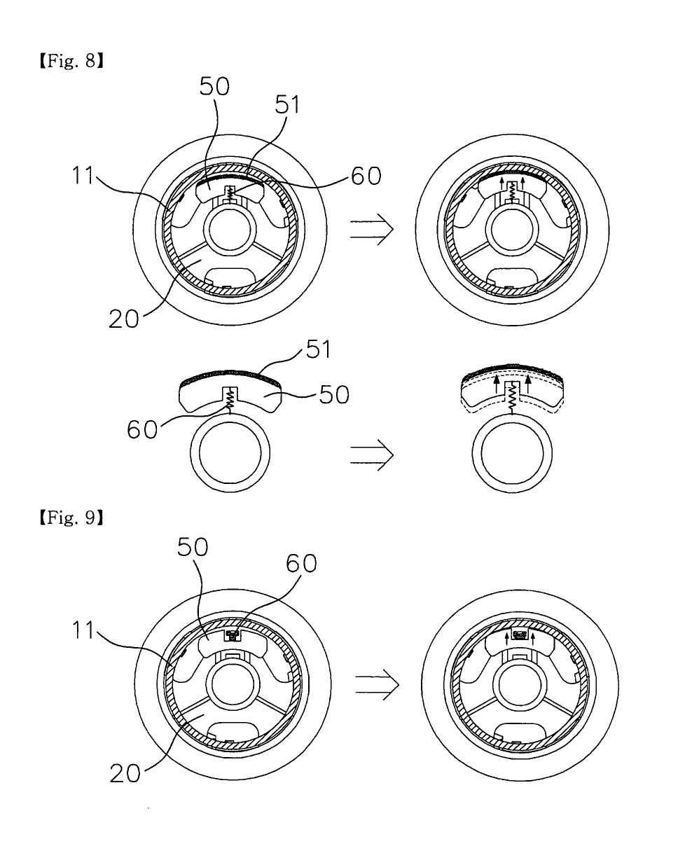

FIG. 7 is a cutaway perspective view showing the tape measure according to the second embodiment of the present invention, and FIG. 8 is a view illustrating the operation of FIG. 7.

Only parts different from those of the first embodiment will be described herein. If no special mention is made, it is to be understood that the same parts as the first embodiment are used in the second embodiment.

According to this embodiment, the rotary brake part 50 is provided to rectilinearly move along the sidewall of the bobbin 20, that is, to perform a sliding motion.

Further, the second elastic member 60 uses a coil spring, which is secured at one end thereof to the bobbin 20, and is secured at the other end thereof to the rotary brake part 50.

Thus, the second elastic member 60 elastically supports the rectilinear motion of the rotary brake part 50, thus elastically biasing the rotary brake part 50 in a direction leading away from the stationary brake part 11.

Further, friction-increasing rubber 51 is provided on the surface of the rotary brake part 50.

According to the second embodiment, when the bobbin 20 rotates, so that the rotary brake part 50 rotates and the rotating speed of the bobbin 20 exceeds a predetermined speed, the centrifugal force acting on the rotary brake part 50 increases. Thereby, the rotary brake part 50 overcomes the elastic force of the second elastic member 60, and moves towards the stationary brake part 11. Consequently, the friction-increasing rubber 51 of the rotary brake part 50 comes into contact with the stationary brake part 11, thus generating frictional force.

Of course, the friction-increasing rubber may be provided on the surface of the stationary brake part 11. Further, a friction-increasing synthetic resin material may be used in place of the friction-increasing rubber.

FIG. 9 shows the modification of the second embodiment. In this case, the second elastic member 60 uses a compressible rubber material.

The second elastic material 60 of the present invention may be any object having elastic force, such as a plate spring or an elastic cord, in addition to the above-mentioned coil spring, torsion spring, and compressible rubber material.

Further, the present invention may further include a speed reduction indicating unit, which indicates that the rotary brake part 50 contacts the stationary brake part 11, or the speed of the bobbin 20 is reduced.

As a visual speed reduction indicating unit, a transparent window is provided at the position where the rotary brake part 50 contacts the stationary brake part 11. At normal times, the rotary brake part 50 is not observed. However, when the rotary brake part 50 performs a speed reducing operation, the rotary brake part 50 can be observed through the transparent window. Of course, it is preferable that the rotary brake part 50 have a distinguishable color.

As an audible speed reduction indicating unit, a melody unit, which is operated as the rotary brake part 50 moves, may be used. If the melody unit is used as such, the melody unit introduces the aspect of entertainment, thus giving a user a pleasure in using the tape measure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As described above, the present invention provides a tape measure, which is capable of self-regulating its speed so that the retraction speed of a blade is not too fast or slow, and does not introduce any noise to the working environment in the case where the speed of the blade is not reduced.

What is claimed is:

1. A tape measure with a self-regulating speed control mechanism, having a bobbin rotatably provided in a casing, a blade wound at a first end thereof around the bobbin and exposed at a second end thereof outside the casing, with graduations marked on the blade in a longitudinal direction thereof so as to measure lengths, and a first elastic member providing rotating force to the bobbin so as to restore the extended blade to an original position thereof, the tape measure comprising:
a rotary brake part provided on a sidewall of the bobbin in such a way as to change a distance from a rotation center of the bobbin, and rotated along with the bobbin when the bobbin rotates, so that centrifugal force acts on the rotary brake part;
a stationary brake part protruding from the casing towards the sidewall of the bobbin on which the rotary brake part is provided; and
a second elastic member provided on the sidewall of the bobbin, and elastically biasing the rotary brake part in a direction leading away from the stationary brake part;
wherein when the centrifugal force acting on the rotary brake part by rotation of the bobbin exceeds an elastic force of the second elastic member, the rotary brake part comes into contact with the stationary brake part, thus preventing a rotating speed of the bobbin from increasing.

2. The tape measure as set forth in claim 1, wherein
the rotary brake part is supported by the sidewall of the bobbin via a pivot shaft, and
the second elastic member functions to elastically support a pivoting rotation of the rotary brake part.

3. The tape measure as set forth in claim 2, wherein the second elastic member is selected from one of a torsion spring, a plate spring, a coil spring, an elastic cord, and a compressible rubber material.

4. The tape measure as set forth in claim 1, wherein
the rotary brake part is rectilinearly movable along the side wall of the bobbin, and
the second elastic member functions to elastically support rectilinear motion of the rotary brake part.

5. The tape measure as set forth in claim 4, wherein the second elastic member is selected from one of a coil spring, an elastic cord, and a compressible rubber material.

6. The tape measure as set forth in claim 1, further comprising:
a speed reduction indicating unit for indicating whether the rotary brake part contacts the stationary brake part.

7. The tape measure as set forth in claim 1, wherein the stationary brake part has a circular ring shape such that a center thereof is identical with the rotation center of the bobbin.

8. The tape measure as set forth in claim 1, wherein friction-increasing rubber or a friction-increasing synthetic resin material is provided on a surface of the rotary brake part contacting the stationary brake part.

9. The tape measure as set forth in claim 1, wherein friction-increasing rubber or a friction-increasing synthetic resin material is provided on a surface of the stationary brake part contacting the rotary brake part.
